(19) United States
(12) Patent Application Publication
(10) Pub. No.: US 2013/0159491 A1
(43) Pub. Date: Jun. 20, 2013

(54) COMMUNICATION SYSTEM, NETWORK STORAGE, AND SERVER DEVICE

(71) Applicant: Buffalo Inc., Nagoya-shi (JP)

(72) Inventor: Yukihito HARA, Nagoya-shi (JP)

(73) Assignee: BUFFALO INC., Nagoya-shi (JP)

(21) Appl. No.: 13/718,708

(22) Filed: Dec. 18, 2012

(30) Foreign Application Priority Data
Dec. 20, 2011 (JP) 2011-278244

(51) Int. Cl. H04L 29/08

(52) U.S. Cl. CPC H04L 67/16
USPC 709/223

(57) ABSTRACT

A communication system includes a server device that is provided on a first network and is capable of connecting to a user terminal. A network storage is included that is connected to a second network different from the first network and is capable of connecting to the server device, wherein the network storage transmits a storage request signal to the server device in response to predetermined operation, the server device transitions to a standby state in response to the storage request signal, the user terminal transmits, to the server device, a user request signal including storage identification information to identify the network storage and terminal identification information to identify the user terminal by using setup information uniquely associated with the network storage, and the server device associates the user terminal with the network storage if receiving the user request signal from the user terminal in the standby state.

### CROSS-REFERENCE TO RELATED APPLICATION

This non-provisional application claims priority under 35 U.S.C. §119(a) to Japanese Patent Application No. 2011-278244 filed in Japan on Dec. 20, 2011, the entire contents of which are hereby incorporated by reference.

### BACKGROUND

The present disclosure relates to a communication system that performs pairing between a user terminal and a network storage, a network storage, and a server device.

In recent years, the network storage (network attached storage (NAS)) having a high-capacity external storage device is utilized in homes and offices. Such a network storage is connected to a LAN (Local Area Network) in the home or office.

Meanwhile, regarding portable user terminals such as smartphones, which are becoming popular recently, there is a need to utilize the network storage in order to compensate for the storage capacity of the user terminal and store the backup. The portable user terminal such as the smartphone is frequently used not only in homes and offices but also at outside locations because of the nature of the device. At outside locations, the user terminal is connected to a wide area network such as the Internet via a cell-phone line or the like.

So, it is required to enable access from such a user terminal to a network storage connected to a LAN in the home or office via a wide area network. In general, a gateway (router) is set between a wide area network and a LAN and this router performs translation from an IP address used in the connection to the wide area network to an IP address used on the LAN side (network address translation (NAT)). Therefore, it is impossible for the user terminal connecting to the wide area network to directly specify the IP address of a device (here, network storage) connected to the LAN and access the device connected to the LAN. This is because the address in the LAN is not the address on the wide area network side. To address this, as techniques enabling access from the above-described user terminal to a network storage, e.g. the following functions have been proposed: a function called “Web access” (“INTERNETWatch, Initial B by Shimizu Masashi, the 409th installment: utilization of NAS from outside location by application for iPhone/iPad, Buffalo “WebAccess i,”” http://internet.watch.impress.co.jp/docs/column/shimizu/2 0100928_{—}396441.html); and a function called “CloudStor” or “Pogoplug” (e.g. “PCWatch, [CES 2011 Report] Buffalo Part, NAS including Pogoplug function and TeraStation in which eight HDDs can be incorporated,” http://pc.watch.impress.co.jp/docs/news/20110111_{—}419544.h tml).

In “Web access,” direct access between a user terminal and a network storage is enabled by utilizing the UPnP (Universal Plug and Play) function of a router to which the network storage is connected. In “CloudStor” and “Pogoplug,” a relay server provided on a wide area network performs associating (pairing) between a user terminal and a network storage to enable a relay of data between the user terminal and the network storage.

As a technique for the pairing between two devices, a technique in which terminal identification information to identify one device (e.g. user terminal) is registered in the other device (e.g. television) has also been proposed (e.g. Japanese Patent Laid-open No. 2008-278266).

However, in “Web access,” in access from a wide area network to a network storage connected to a LAN of a router, the router needs to be equipped with the UPnP function. If the router does not have the UPnP function, the user needs to configure the settings for port forwarding of the router for the access to the network storage beyond the NAT of such a router. In such a case, a complicated procedure of the settings is necessary. Furthermore, in this “Web access,” the user terminal cannot connect to the network storage if the router is not equipped with the UPnP function and the router is also not compliant with change in the settings for port forwarding or if the settings for port forwarding are not correctly configured although the router is equipped with the UPnP function.

In “CloudStor” and “Pogoplug,” such a problem does not occur because a relay server is utilized. However, in pairing between a user terminal and a network storage, the user needs to configure the settings by using a PC or the like connected to the same network as that of the network storage. Particularly for the user who is unfamiliar with the IT techniques, this is troublesome and the settings are difficult. Thus, it is difficult to utilize the network storage.

So, the present disclosure is made in order to solve the above-described problem and one of objects thereof is to provide a communication system, a network storage, and a server device that enable easy pairing between a user terminal and a network storage.

### SUMMARY

A communication system according to one aspect of the present disclosure includes a server device that is provided on a first network and is configured to connect to a user terminal, and a network storage that is connected to a second network different from the first network and is configured to connect to the server device. The network storage transmits a storage request signal to the server device in response to a predetermined operation of the network storage. The server device transitions to a standby state in response to receiving the storage request signal. The user terminal transmits, to the server device, a user request signal including storage identification information to identify the network storage and terminal identification information to identify the user terminal by using setup information uniquely associated with the network storage. The server device associates the user terminal with the network storage in response to receiving the user request signal from the user terminal while in the standby state.

### BRIEF DESCRIPTION OF THE DRAWINGS

FIG. 1 is a diagram showing a communication system according to an embodiment of the present disclosure;

FIG. 2 is a block diagram showing a network storage according to the embodiment of the present disclosure;

FIG. 3 is a block diagram showing a user terminal according to the embodiment of the present disclosure;

FIG. 4 is a block diagram showing a server device according to the embodiment of the present disclosure;

FIG. 5 is a sequence diagram showing the operation of the communication system according to the embodiment of the present disclosure;

FIG. 6 is another sequence diagram showing the operation of the communication system according to the embodiment of the present disclosure; and

FIG. 7 is a diagram showing a network storage according to one example of the embodiment of the present disclosure.

### DETAILED DESCRIPTION

In the following description, a network storage and a server device according to an embodiment of the present disclosure will be described with reference to the drawings. In the following description of the drawings, the same part is given the same symbol.

The drawings are schematic and the ratio of the respective sizes is different from the actual ratio. That is, the specific sizes and so forth should be determined by taking the following description into consideration. Furthermore, part with difference in the mutual size relationship and ratio between the drawings is also included.

A communication system according to an embodiment of the present disclosure includes a server device that is provided on a first network and is capable of connecting to a user terminal and a network storage that is connected to a second network different from the first network and is capable of connecting to the server device. The network storage transmits a storage request signal to the server device in response to predetermined operation to the network storage. The server device transitions to a standby state in response to the storage request signal. The user terminal transmits, to the server device, a user request signal including storage identification information to identify the network storage and terminal identification information to identify the user terminal by using setup information uniquely associated with the network storage. The server device associates the user terminal with the network storage if receiving the user request signal from the user terminal in the standby state.

In this embodiment, the server device transitions to the standby state in response to the storage request signal transmitted from the network storage in response to the predetermined operation to the network storage, and associates the user terminal with the network storage if receiving the user request signal in the standby state.

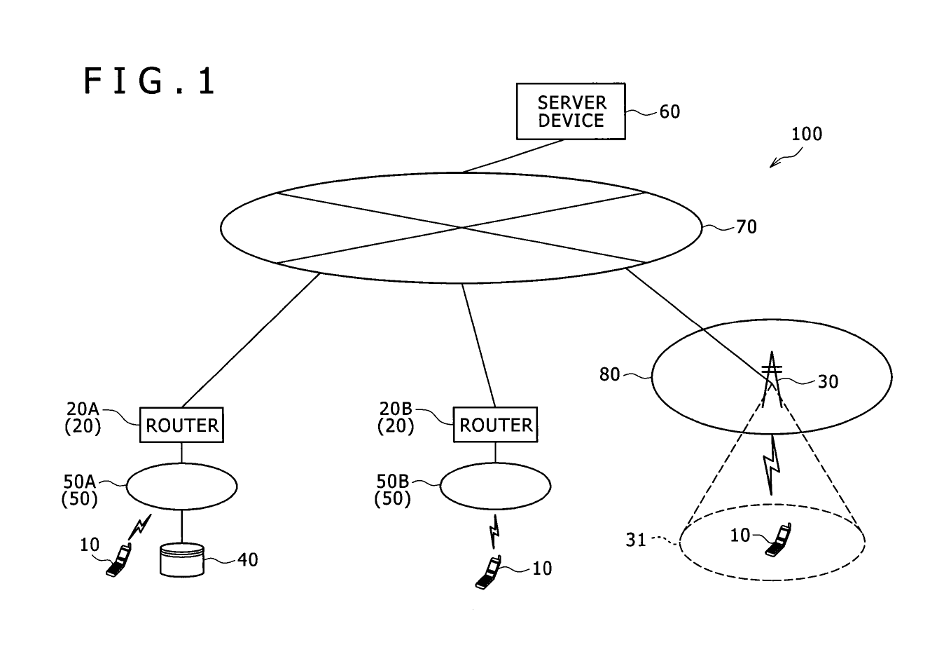

The communication system according to the embodiment of the present disclosure will be described below. FIG. 1 is a diagram showing a communication system 100 according to the embodiment of the present disclosure.

As shown in FIG. 1, this communication system 100 has a user terminal 10, a router 20, a wireless base station 30, a network storage 40, a home network SOA, an external network 50B, a server device 60, a wide area network 70, and a mobile communication network 80.

The user terminal 10 is e.g. a cell phone such as a smartphone or a digital camera. This user terminal 10 establishes a wireless connection with the wireless base station 30 provided in the mobile communication network 80. This user terminal 10 may have a function to establish a wireless connection with the router 20. Details of this user terminal 10 will be described later.

The router 20 is connected to e.g. the wireless or wired LAN 50. This router 20 is also connected to the wide area network 70. The router 20 has a function to perform network address translation (NAT) to translate an IP address on the side of the LAN 50 to an IP address on the side of the wide area network 70 when a device connected to the LAN 50 accesses a device connected to the wide area network 70.

Furthermore, this router 20 has a function as a wireless LAN access point and is capable of communication by a wireless LAN with the user terminal 10 that exists in the cover area as the range of the reach of radio waves output from the router 20. In one example, a router 20A and a router 20B are provided as the router 20.

In the description of the present embodiment, the router 20A is connected to an in-house LAN in the user's home or the like and the wide area network 70. The router 20B is connected to a LAN other than the in-house LAN (e.g. public wireless LAN) and the wide area network 70.

The wireless base station 30 establishes a wireless connection with the user terminal 10 that exists in a cover area 31 as the range of the reach of radio waves output from the wireless base station 30, and wirelessly performs communication.

The network storage 40 has a data storing function and a communication function. In the present embodiment, the network storage 40 is connected to the in-house LAN in the user's home or the like. For example, the network storage 40 is connected to a wired LAN port of the router 20A via a network cable. However, it is enough that the network storage 40 is connected to the router 20A by a network interface. For example, the network storage 40 may be wirelessly connected to the router 20A. Details of this network storage 40 will be described later.

The home network 50A is one example of the in-house LAN. This home network 50A is one example of the second network. The external network 50B is one example of the LAN. The mobile communication network 80 includes the wireless base station 30 and so forth. This mobile communication network 80 is managed by a communications carrier.

The server device 60 is provided at such a position as to enable connection via the wide area network 70. An IP address for communication via the wide area network 70 is assigned to this server device 60. Furthermore, this server device 60 can connect to the network storage 40 via the second network (home network 50A). Moreover, this server device 60 can connect also to the user terminal 10.

Communication between the server device 60 and the user terminal 10 may be performed via the external network 50B or the mobile communication network 80 or may be performed via the home network 50A. The access path between the user terminal 10 and the server device 60 may be the same as the access path between the network storage 40 and the server device 60 on the side of the wide area network 70.

The server device 60 associates the user terminal 10 with the network storage 40. Details of this server device 60 will be described later.

The wide area network 70 is e.g. the Internet, to which a protocol such as the TCP/IP is applied. Various web servers are connected to the wide area network 70. In the embodiment of the present disclosure, the network to which the server device 60 is connected is one example of the first network. That is, in this example, the first network is part of the wide area network 70.

The network address such as the IP address on the side of the wide area network 70 (first network) is different from the network address such as the IP address assigned on the side of the home network 50A (second network).

Specifically, an IP address used in the home network 50A is assigned to the network storage 40 connected to the home network 50A. Therefore, although the IP address of the network storage 40 in the home network 50A is known, it is impossible to access the network storage 40 via the wide area network 70. For the access to the network storage 40 via the wide area network 70, it is necessary to execute network address translation (NAT) processing to translate the IP address of the router of the home network 50A (here, router 20A), connected to the wide area network 70, on the side of the wide area network 70 to the IP address of the network storage 40 (address on the side of the home network 50A).

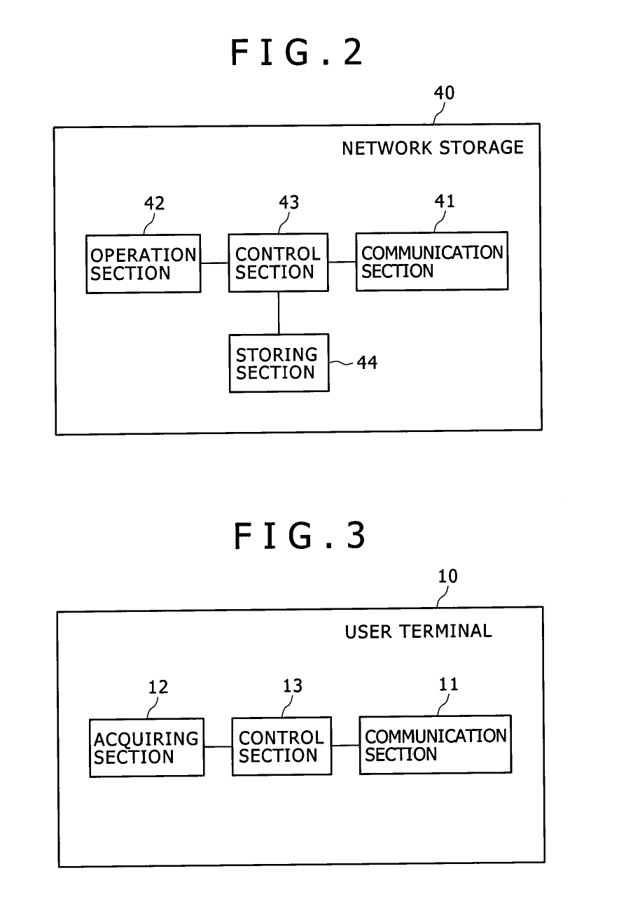

Next, the network storage according to the present embodiment will be described below. FIG. 2 is a block diagram showing the network storage 40 according to an embodiment of the present disclosure.

As shown in FIG. 2, the network storage 40 in the present embodiment has a communication section 41, an operation section 42, a control section 43, and a storing section 44.

The communication section 41 is e.g. a wired LAN module. The communication section 41 communicates with the server device 60 via the second network (home network 50A).

The operation section 42 includes a button and so forth. In one example of the present embodiment, the storage request signal is transmitted by predetermined operation to the operation section 42 as described later. This storage request signal is a signal for causing the server device 60 to transition to the standby state to wait for the user request signal transmitted from the user terminal 10. The storage request signal includes at least the storage identification information to identify the network storage 40. The storage identification information is e.g. an ID assigned to the network storage 40 or the MAC (Media Access Control) address of the network storage 40.

The control section 43 controls the network storage 40. For example, this control section 43 executes processing of instructing the communication section 41 to transmit the storage request signal in response to the predetermined operation to the operation section 42.

When the instruction is made from the control section 43, the communication section 41 transmits the storage request signal to the server device 60 via the second network (home network 50A).

The storing section 44 is a hard disk or the like. Alternatively, the storing section 44 is a solid state drive (SSD) configured by a flash memory.

The user terminal according to the present embodiment will be described below. FIG. 3 is a block diagram showing the user terminal 10 according to the embodiment of the present disclosure.

As shown in FIG. 3, the user terminal has a communication section 11, an acquiring section 12, and a control section 13.

The communication section 11 is so configured as to include an antenna and a wireless module. The communication section 11 has a function to detect radio waves output from the wireless base station 30 and establish a wireless connection with the wireless base station 30. The communication section 11 may detect radio waves output from the router 20 and establish a wireless connection with the router 20.

This communication section 11 also communicates with the server device 60. The communication section 11 communicates with the server device 60 via the home network 50A or the external network 50B or the mobile communication network 80.

The acquiring section 12 is an input interface, a camera, etc. This acquiring section 12 acquires setup information uniquely associated with the network storage 40.

The acquired setup information includes at least information for access to the server device 60 (e.g. URL (Uniform Resource Locator) of the server device 60) and the storage identification information to identify the network storage 40.

The setup information is e.g. a set of URL information for access to the server device 60 and the storage identification information. The storage identification information such as the MAC address of the network storage 40 may be included in the URL information. Hereinafter, the URL information that does not include the storage identification information will be referred to as “general-purpose URL information,” and the URL information including the storage identification information will be referred to as “individual URL information.” For example, when the URL of a webpage for setup of the server device 60 is

http://aaa.bbb.ccc/nassetup.html, this URL information does not include the storage identification information and therefore is general-purpose URL information. On the other hand, when URL information with e.g. the following description as a parameter is used in order to request setup of a specific network storage to this webpage:

http://aaa.bbb.ccc/nassetup.html?target=xxx.yyy.zzz, this URL information includes xxx.yyy.zzz as the storage identification information and thus is referred to as individual URL information.

As one example, if the acquiring section 12 has a camera, the setup information may be offered by a QR CODE (registered trademark) or a barcode printed on an instruction manual or the like supplied with the network storage 40. The acquiring section 12 decodes the imaged QR CODE (registered trademark) or the barcode to acquire the setup information.

Alternatively, if the acquiring section 12 is an input interface enabling input of a string, the setup information may be offered as a character string printed on an instruction manual or the like supplied with the network storage 40. The acquiring section 12 accepts input of this string by the user to acquire the setup information.

The control section 13 controls the user terminal 10. For example, when acquiring the setup information, the control section 13 instructs the communication section 11 to transmit the user request signal including the terminal identification information and the storage identification information. Specifically, this user request signal is transmitted by using the setup information including the URL of the server device 60. The terminal identification information is e.g. an e-mail address assigned to the user terminal 10 from a communications carrier.

If the setup information is individual URL information, because the user request signal is transmitted by using the setup information, the storage identification information does not need to be additionally included in the user request signal and the storage identification information is transmitted as part of the URL.

The user request signal includes at least the terminal identification information to identify the user terminal 10 in addition to the setup information.

The control section 13 may instruct the communication section 11 to transmit a password setting response signal including a password in response to an instruction from the server device 60 (e.g. password setting request signal to be described later). The password is input to the user terminal 10 by the user.

The communication section 11 transmits the user request signal to the server device 60 via the first network (external network 50B or mobile communication network 80) in response to the instruction from the control section 13. Furthermore, the communication section 11 transmits the password setting response signal to the server device 60 via the first network (external network 50B or mobile communication network 80) in response to the instruction from the control section 13.

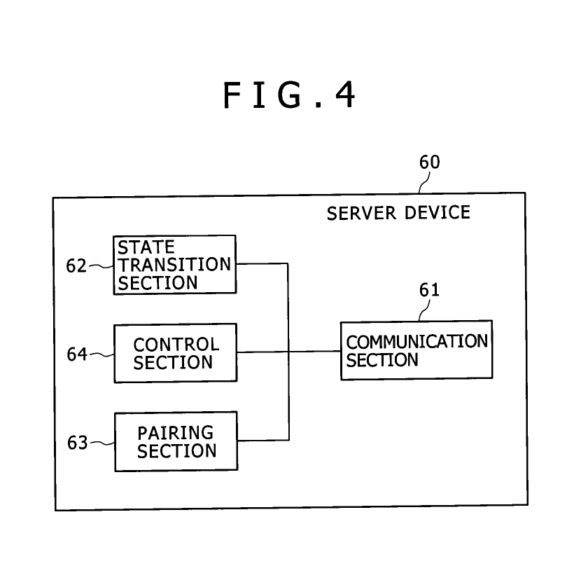

Next, the server device according to the present embodiment will be described below. FIG. 4 is a block diagram showing the server device 60 according to the embodiment of the present disclosure.

As shown in FIG. 4, the server device 60 has a communication section 61, a state transition section 62, a pairing section 63, and a control section 64.

The communication section 61 communicates with the network storage 40 via the second network (home network 50A). This communication section 61 also communicates with the user terminal 10.

This communication section 61 receives the storage request signal from the network storage 40. Furthermore, this communication section 61 receives the user request signal and the password setting response from the user terminal 10.

The state transition section 62 transitions to the standby state to wait for the user request signal that should be transmitted from the user terminal 10 in response to the storage request signal. The standby state may optionally be canceled at the elapse of a predetermined period.

If the user request signal is received in the standby state, the pairing section 63 performs associating (pairing) between the user terminal 10 and the network storage 40. Specifically, the pairing section 63 stores the terminal identification information and the storage identification information with a recognized association therebetween.

As described above, the storage identification information to identify the network storage 40 and the terminal identification information to identify the user terminal 10 are included in the user request signal. Therefore, this user request signal enables pairing.

If the setup information is individual URL information, the pairing section 63 can refer to the storage identification information included in this individual URL information and specify the storage identification information of the network storage 40.

The pairing section 63 rejects pairing when receiving the user request signal in a state other than the standby state.

The control section 64 controls the server device 60. For example, the control section 64 instructs the state transition section 62 to transition to the standby state in response to the storage request signal. The control section 64 instructs the pairing section 63 to perform pairing in response to the user request signal.

Furthermore, in response to reception of the user request signal in the standby state, the control section 64 instructs the communication section 61 to transmit a password setting request to request setting of a password. In response to a password setting response including the password, the control section 64 instructs the pairing section 63 to associate the password with the information that associates the user terminal 10 with the network storage 40.

The control section 64 may instruct the pairing section 63 to perform pairing of the terminal identification information, the storage identification information, and the password in response to the password setting response.

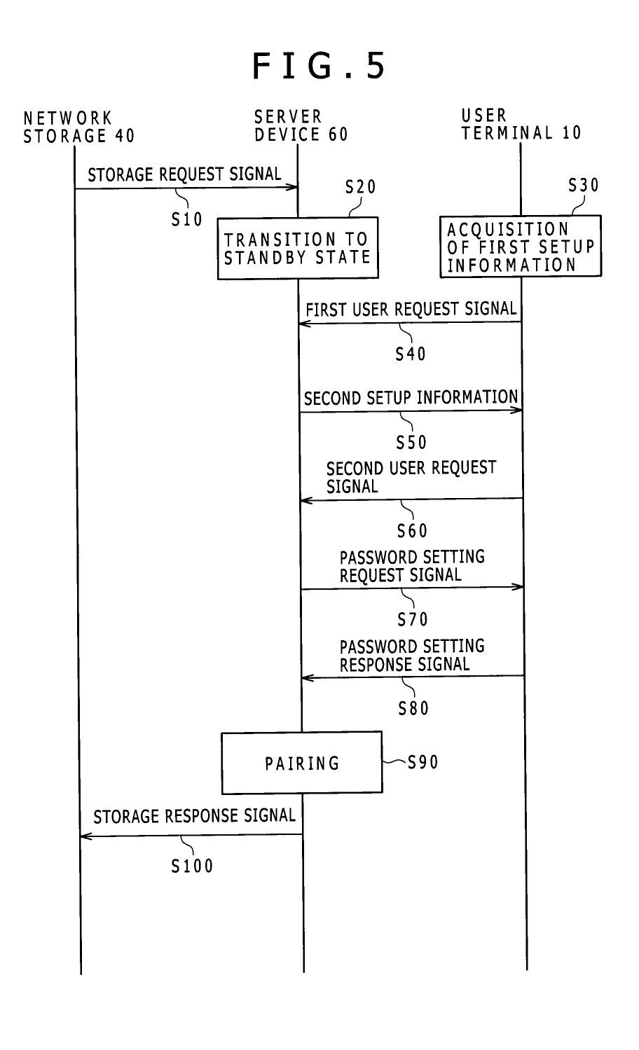

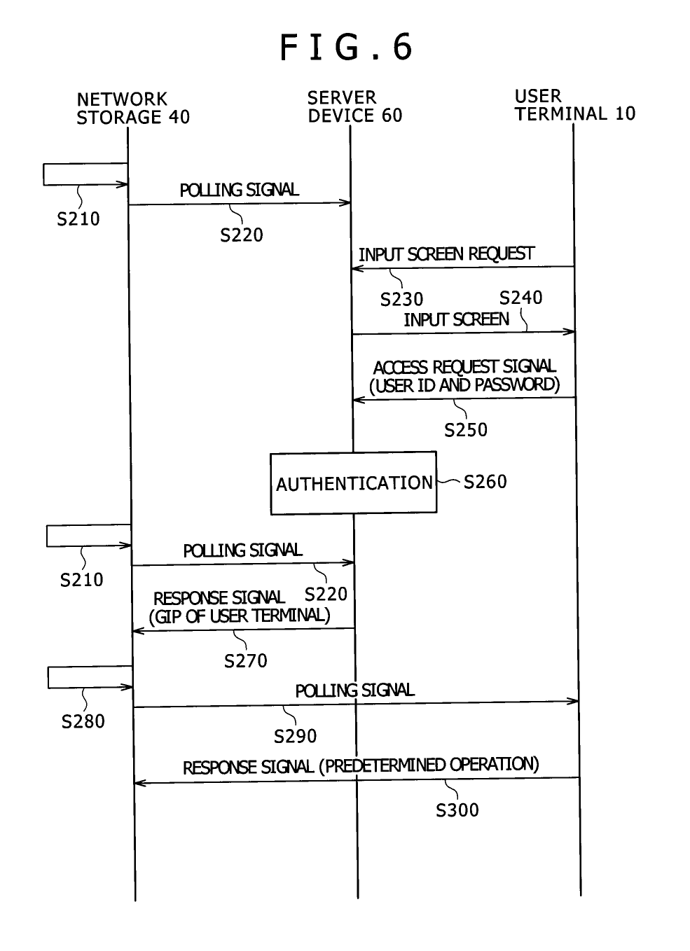

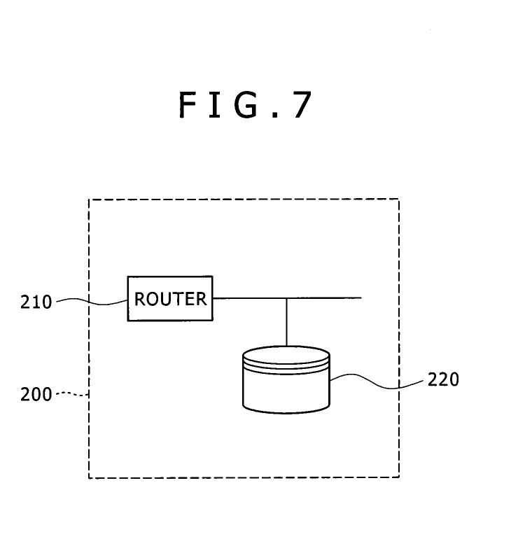

Next, the operation of the communication system according to the present embodiment will be described below. FIG. 5 and FIG. 6 are sequence diagrams showing the operation of the communication system 100 according to the present embodiment.

First, the procedure of pairing between the terminal identification information and the storage identification information will be described with reference to FIG. 5.

In this procedure, first setup information and second setup information are used as the setup information. In other words, pairing between terminal identification information and storage identification information is performed by two-stage processing.

The first setup information is e.g. a set of the general-purpose URL information of the server device 60 and the storage identification information and is acquired by e.g. reading a QR CODE (registered trademark) or a barcode. The second setup information is e.g. the individual URL information of the server device 60 uniquely associated with the network storage 40 and is transmitted from the server device 60 to the user terminal 10.

The second setup information (individual URL information) may be one-time URL information that permits only one time of access. In this individual URL information, the storage identification information such as the MAC address of the network storage 40 is included.

Although the first setup information and the second setup information are used as the setup information in FIG. 5, the present embodiment is not limited thereto. Specifically, the second setup information may be omitted and the pairing between the terminal identification information and the storage identification information may be performed by one-stage processing. In such a case, the individual URL information of the server device 60 uniquely associated with the network storage 40 may be employed as the first setup information. Furthermore, the first setup information of this case may be acquired by reading a QR CODE (registered trademark) or a barcode.

As shown in FIG. 5, in a step S10, when predetermined operation (button pressing-down etc.) is performed, the network storage 40 transmits the storage request signal to the server device 60 via the second network (home network 50A). The storage request signal includes the storage identification information to identify the network storage 40.

In a step S20, in response to the storage request signal, the server device 60 transitions to the standby state to wait for the user request signal transmitted from the user terminal 10. It is optional for the standby state to be canceled at the elapse of a predetermined period.

In a step S30, the user terminal 10 acquires the first setup information uniquely associated with the network storage 40. As described above, the first setup information is a set of the general-purpose URL information of the server device 60 and the storage identification information. The step S30 may be carried out prior to the step S10 and the step S20.

In a step S40, the user terminal 10 transmits a first user request signal including the terminal identification information and the storage identification information to the server device 60. The first user request signal is transmitted by using the first setup information. In this procedure, a case in which the terminal identification information is an e-mail address will be exemplified.

In a step S50, the server device 60 transmits the second setup information to the user terminal 10. As described above, the second setup information is the individual URL information of the server device 60 uniquely associated with the network storage 40.

The server device 60 transmits a notification of rejection of transmission of the second setup information to the user terminal 10 if receiving the first user request signal in the state in which the standby state has been canceled.

In a step S60, the user terminal 10 transmits a second user request signal including the terminal identification information to the server device 60. The second user request signal is transmitted by using the second setup information. As described above, the second user request signal includes the storage identification information in addition to the destination URL of the server device 60.

In a step S70, the server device 60 transmits the password setting request signal to the user terminal 10. The server device 60 can transmit the password setting request by an e-mail because having acquired the e-mail address as the terminal identification information.

In a step S80, the user terminal 10 transmits the password setting response signal including a password to the server device 60. The password setting response signal may be the individual URL of the server device including the password. Furthermore, this password setting response signal may be transmitted by clicking a setting button. Moreover, if the password setting request is transmitted from the server device 60 by an e-mail, the password may be returned from the user terminal 10 by an e-mail. The setting request and the password may be encrypted.

In a step S90, the server device 60 performs associating (pairing) between the user terminal 10 and the network storage 40. In this procedure, the server device 60 stores the terminal identification information, the storage identification information, and the password in the associated manner.

The server device 60 may transmit a notification of rejection of the pairing to the user terminal 10 if receiving the second user request signal in the state in which the standby state has been canceled (when the state is not the standby state). Furthermore, the server device 60 may transmit a notification of rejection of the pairing to the user terminal 10 if receiving the password setting response signal in the state in which the standby state has been canceled.

If a one-time URL is employed as the second setup information (individual URL information), the server device 60 stores the second setup information received in the past. Then, if it is the second time that access to the server device 60 by use of the same second setup information as that received in the past is performed, the server device 60 transmits a notification of rejection of the pairing to the user terminal 10.

In a step S100, the server device 60 transmits a storage response signal to the network storage 40 via the second network (home network 50A).

Next, the procedure of access to the network storage 40 via the server device 60 by the user terminal 10 will be described below with reference to FIG. 6.

As shown in FIG. 6, the network storage 40 detects that predetermined time has elapsed in a step S210 and transmits a polling signal to the server device 60 via the router 20A in a step S220. The transmission of the polling signal is repeated at predetermined time intervals. The polling signal includes the IP address of the server device 60 as the destination address and includes the IP address of the router 20A used in the connection to the wide area network 70 (IP address of the router 20A on the side of the wide area network 70) as the source address.

In a step S230, the user terminal 10 transmits, to the server device 60, an input screen request signal to request information for displaying an input screen.

In a step S240, the server device 60 transmits the information for displaying an input screen to the user terminal 10. This input screen is utilized in acceptance of input of the storage identification information and the password for example.

In a step S250, the user of the user terminal 10 inputs the storage identification information and the password on a screen displayed by using the information for displaying the input screen. The user terminal 10 transmits an access request signal including the input storage identification information and password to the server device 60. The access request signal includes the IP address of the server device 60 as the destination address and includes the IP address of the user terminal 10 used in the connection to the wide area network 70 (IP address on the side of the wide area network 70) as the source address.

In a step S260, the server device 60 executes processing of authentication by using the storage identification information and the password.

In a step S270, in response to the polling signal received from the network storage 40, the server device 60 transmits a response signal including the IP address of the user terminal 10 used in the connection to the wide area network 70 to the network storage 40 via the router 20A. The response signal may be the access request signal received from the user terminal 10. The response signal includes the IP address of the router 20A used in the connection to the wide area network 70 (IP address of the router 20A on the side of the wide area network 70) as the destination address and includes the IP address of the server device 60 as the source address.

In a step S280, the network storage 40 detects that predetermined time has elapsed. In a step S290, the network storage 40 transmits a polling signal to the user terminal 10 via the router 20A. The polling signal includes the IP address of the user terminal 10 included in the response signal as the destination address and includes the IP address of the router 20A used in the connection to the wide area network 70 as the source address.

In a step S300, in response to the polling signal received from the network storage 40, the user terminal 10 transmits a response signal including predetermined operation to the network storage 40 via the router 20A. The predetermined operation is operation such as data upload or data download. The response signal includes the IP address of the router 20A used in the connection to the wide area network 70 as the destination address and includes the IP address of the user terminal 10 as the source address.

The router 20A translates the IP address of the router 20A included in the response signal transmitted in response to the polling signal to the address of the network storage 40 (NAT function).

In the present embodiment, the server device 60 transitions to the standby state in response to the storage request signal transmitted from the network storage 40 in response to the predetermined operation to the network storage 40, and associates the user terminal 10 with the network storage 40 if receiving the user request signal in the standby state.

As above, the user does not need to input the identification information to identify the network storage 40 and thus pairing between the user terminal 10 and the network storage 40 can be easily performed. Furthermore, because the predetermined operation to the network storage 40 is necessary in the pairing processing, pairing that is not intended by the user is suppressed.

Furthermore, because the response signal is transmitted as a response to the polling from the network storage 40, it is possible to directly transmit the response signal from the user terminal 10 to the network storage 40 beyond the NAT of the router 20A.

In the present embodiment, the first setup information and the second setup information are used as the setup information. The second setup information may be individual URL information (one-time URL). In this case, pairing that is not intended by the user is further suppressed.

Modification example 1 of the first embodiment will be described below. In the following, difference from the first embodiment will be mainly described.

The above description is based on the assumption that the network storage is the network storage 40 having a function to communicate with the server device 60 via a router. However, the network storage may be a router connected to the second network and an external storage connected to the router.

Specifically, as shown in FIG. 7, a network storage 200 includes a router 210 and an external storage 220.

The router 210 configures an in-house LAN in the user's home or the like. The router 210 may be a wireless router or may be a wired router. In this example, the router 210 has part of the functions possessed by the already-described network storage 40 (communication function). For example, the router 210 has a configuration equivalent to the communication section 41 and the control section 43.

The external storage 220 has a data storing function. This external storage 220 does not need to have a communication function. In this example of the present embodiment, the external storage 220 has part of the functions possessed by the above-described network storage 40. For example, the external storage 220 has a configuration equivalent to the above-described operation section 42. The external storage 220 is connected to the router 210 via a bus interface (e.g. USB or IEEE 1394).

Although the present disclosure is explained based on the above-described embodiment, it should not be understood that the description and drawings as part of this disclosure limit this disclosure. From this disclosure, various alternative embodiments, working examples, and operational techniques will be apparent for those skilled in the art.

The case in which the user terminal 10 has a wireless function is exemplified in the above description. However, the user terminal 10 may be a terminal that does not have a wireless function and has a function to connect to a wired LAN.

Although there is no particular mention in the above-described embodiment, a program causing a computer to carry out the respective steps shown in FIG. 5 and FIG. 6 may be provided. Specifically, a program to carry out the operation of the network storage 40 and a program to carry out the operation of the server device 60 may be provided. The program may be recorded in a non-transitory computer-readable medium. Using a computer-readable medium makes it possible to install the program in a computer. The computer-readable medium in which the program is recorded may be e.g. a recording medium such as a CD-ROM (Compact Disk Read Only Memory) or a DVD-ROM (Digital Versatile Disk Read Only Memory).

In one aspect of this embodiment, the user terminal 10 performs data communication via a cell-phone network such as the 3G or LTE. Besides, it is also capable of data communication via a wireless LAN interface.

The network storage 40 is connected to e.g. a local area network (LAN) in the home of the user of the user terminal 10 or the place of work. Although the bridge of a wireless LAN is connected to the LAN to which this network storage 40 is connected, it is often difficult for the user of the user terminal 10 to connect the user terminal 10 to the LAN via the bridge and then set up the network storage 40 e.g. when this user is unaccustomed to the operation of the device. However, even such a user can utilize data communication via a wireless communication line set up in advance on the carrier side, i.e. via a cell-phone network, in many cases.

So, in the aspect of this embodiment, devices operate in the following manner based on the premise that the user of the user terminal 10 can connect to the server device 60 existing on the Internet via a cell-phone network.

Suppose that, in this aspect, information specific to the network storage 40 (storage identification information) is assigned to this network storage 40 in advance and this storage identification information is distributed with the network storage 40 in such a manner as to be written on paper for example (furthermore, this paper is attached to the chassis of the network storage 40). Furthermore, this network storage 40 has a button. When the user presses down this button, the network storage 40 sends a predetermined signal (setup standby signal) including the storage identification information assigned to this network storage 40 to the address of the server device 60 defined in advance (URL defined as the destination of the setup standby signal in advance). In this aspect of the present embodiment, the setup standby signal may have a form of request for a webpage by use of the HTTP (Hyper Text Transfer Protocol).

The server device 60 receives this setup standby signal and waits for reception of a signal (setup request signal) including the storage identification information included in this setup standby signal from the user terminal 10. The server device 60 in the standby state may time the elapsed time from the start of the standby state, and cancel the standby state to stop the processing if the setup request signal is not received before time defined in advance elapses.

The user of the user terminal 10 inputs, to the user terminal 10, the storage identification information recorded on the paper or the like distributed with the network storage 40, and sends out an e-mail including this storage identification information or the URL of a webpage including the storage identification information as the setup request signal.

When receiving the setup request signal from the user terminal 10, the server device 60 compares the storage identification information included in this setup request signal with the storage identification information included in the setup standby signal as the trigger for the standby state. When they correspond with each other, the server device 60 transmits a webpage defined in advance to the user terminal 10, which is the transmission source of this setup request signal.

This webpage may include an entry field of information to identify the user terminal 10 (terminal identification information), such as an entry field of the phone number and the e-mail address of the user terminal 10. Furthermore, an entry field of the password may be included in this webpage. When the user of the user terminal 10 inputs the necessary information to these entry fields and instructs the user terminal 10 to transmit (submit) the information, this input information is accepted by the server device 60.

When acquiring the terminal identification information of the user terminal 10 as the information input on this webpage, the server device 60 associates this acquired terminal identification information with the storage identification information included in the setup request signal received from this user terminal 10 and stores them as pairing information. If a password is input, the server device 60 associates the acquired terminal identification information, the storage identification information included in the setup request signal received from this user terminal 10, and the input password and stores them as the pairing information.

Thereafter, the server device 60 may transmit predetermined information to the network storage 40 as a response to the setup standby signal.

From then on, when the user of the user terminal 10 accesses the predetermined URL of the server device 60 (URL of the webpage defined as the site for access to the network storage 40 in advance), the server device 60 transmits a webpage prompting input of the identification information of this user terminal 10 and the password.

The user of the user terminal 10 inputs the terminal identification information of the user terminal 10 (phone number, e-mail address, etc. of the user terminal 10) and the password on this webpage and transmits (submits) them.

The server device 60 searches for the pairing information including this transmitted terminal identification information. When the pairing information including the transmitted terminal identification information is found, the server device 60 compares the password included in this found pairing information with the transmitted password. If the password included in the found pairing information does not correspond with the transmitted password, the server device 60 transmits a webpage indicating the occurrence of an error to the user terminal 10.

If the password included in the pairing information found as a result of the search corresponds with the transmitted password, the server device 60 accepts an instruction from the user terminal 10 to the network storage 40 (e.g. instruction for presentation of a file list and file acquisition). Then, the server device 60 refers to the storage identification information included in the pairing information found in this search and transmits the instruction accepted from the user terminal 10 to the network storage 40 identified by this storage identification information.

When the network storage 40 transmits information in response to this instruction, the server device 60 sends out this transmitted information to the user terminal 10.

The network storage 40 may transmit the WAN (wide area network)-side IP address of the router to which this network storage 40 is connected to the server device 60, a domain name server defined in advance, and so forth at every predetermined timing (e.g. periodically). If such a configuration is employed, even when the network storage 40 is connected via a router connected to the Internet with assignment of an IP address thereto from a provider, the server device 60 can get to know the IP address assigned to this router at the predetermined timing and access the network storage 40.

In another aspect of the present embodiment, the server device 60 may operate in the following manner when a request for access to the network storage 40 is issued from the user terminal 10 after pairing.

In this aspect, the network storage 40 accesses the server device 60 at every predetermined timing (e.g. periodically) and inquires whether or not a request to the network storage 40 is issued from the user terminal 10. This inquiry can also be performed by utilizing the HTTP.

Specifically, when the user of the user terminal 10 accesses the predetermined URL of the server device 60 (URL of the webpage defined as the site for access to the network storage 40 in advance), the server device 60 transmits a webpage prompting input of the identification information of this user terminal 10 and the password.

The user of the user terminal 10 inputs the terminal identification information of the user terminal 10 (phone number, e-mail address, etc. of the user terminal 10) and the password on this webpage and transmits (submits) them.

The server device 60 searches for the pairing information including this transmitted terminal identification information. When the pairing information including the transmitted terminal identification information is found, the server device 60 compares the password included in this found pairing information with the transmitted password. If the password included in the found pairing information does not correspond with the transmitted password, the server device 60 transmits a webpage indicating the occurrence of an error to the user terminal 10.

If the password included in the pairing information found as a result of the search corresponds with the transmitted password, the server device 60 accepts an instruction from the user terminal 10 to the network storage 40 (e.g. instruction for presentation of a file list and file acquisition). Then, the server device 60 associates this instruction with the terminal identification information of the user terminal 10 as the transmission source of the instruction and stores the instruction.

The server device 60 receives an inquiry from a certain network storage 40. In this inquiry, the storage identification information of this network storage 40 is included.

The server device 60 extracts the storage identification information included in the inquiry and searches for the pairing information including this extracted storage identification information (referred to as storage-of-interest identification information). If the pairing information including this storage-of-interest identification information is absent, the server device 60 discards this inquiry.

If the pairing information including the above-described storage-of-interest identification information is found by the search, the server device 60 searches for the instruction stored in association with the terminal identification information included in the pairing information found by this search (referred to as terminal-of-interest identification information). If such an instruction is absent, the server device 60 ends the processing (makes no response).

If the instruction stored in association with the terminal-of-interest identification information is found by the search, the server device 60 transmits the instruction found by this search to the network storage 40 identified by the storage-of-interest identification information.

Upon transmission of information by the network storage 40 in response to this instruction, the server device 60 sends out this transmitted information to the user terminal 10.

According to this aspect of the present embodiment, the user of the user terminal 10 can perform pairing with the network storage 40 by data communication via a cell-phone network and utilize the network storage 40 via the server device 60 that retains information of this pairing. At this time, the user is required to only input information that is readily apparent for the user of the user terminal 10, such as the information distributed with the network storage 40 and the e-mail address used in the user terminal 10. Thus, even the user having little experience of setup can utilize the network storage 40 by simple operation.

It should be understood by those skilled in the art that various modifications, combinations, sub-combinations and alternations may occur depending on design requirements and other factors insofar as they are within the scope of the appended claims or the equivalent thereof.

What is claimed is:

1. A communication system comprising:
a server device that is provided on a first network and is configured to connect to a user terminal; and
a network storage that is connected to a second network different from the first network and is configured to connect to the server device, wherein
the network storage transmits a storage request signal to the server device in response to a predetermined operation of the network storage,
the server device transitions to a standby state in response to receiving the storage request signal,
the user terminal transmits, to the server device, a user request signal including storage identification information to identify the network storage and terminal identification information to identify the user terminal by using setup information uniquely associated with the network storage, and
the server device associates the user terminal with the network storage in response to receiving the user request signal from the user terminal while in the standby state.

2. A network storage that is capable of connecting to a server device provided on a first network and is connected to a second network different from the first network, the network storage comprising:
a transmitter that transmits, to the server device, a storage request signal that causes the server device to transition to a standby state to wait for a user request signal transmitted from a user terminal capable of connecting to the server device, in response to a predetermined operation performed by the network storage.

3. The network storage according to claim 2, wherein the network storage includes a router connected to the second network and an external storage connected to the router.

4. A server device that is provided on a first network and is capable of connecting to a network storage and a user terminal via a second network different from the first network, the server device comprising:
a receiver that receives a storage request signal transmitted from the network storage;
a state transition section that transitions to a standby state to wait for a user request signal transmitted from the user terminal in response to receiving the storage request signal; and
a pairing section that associates the user terminal with the network storage while the server device receives the user request signal in the standby state,
wherein the user request signal is transmitted by using setup information uniquely associated with the network storage and includes storage identification information to identify the network storage and terminal identification information to identify the user terminal.

5. The server device according to claim 4, wherein the setup information is acquired by the user terminal through reading of a barcode or a QR CODE.

6. The server device according to claim 4, wherein the setup information is one-time Uniform Resource Locator information.

7. The server device according to claim 4, wherein the standby state is canceled at elapse of a certain period.

8. A method carried out by a server device that is provided on a first network and is capable of connecting to a network storage and a user terminal via a second network different from the first network, the method comprising:
receiving a storage request signal transmitted from the network storage;
transitioning to a standby state to wait for a user request signal transmitted from the user terminal in response to the storage request signal; and
associating the user terminal with the network storage if receiving the user request signal while in the standby state,
wherein the user request signal is transmitted by using setup information uniquely associated with the network storage and includes storage identification information to identify the network storage and terminal identification information to identify the user terminal.
